(19) United States
(12) Patent Application Publication
(10) Pub. No.: US 2026/0175988 A1
(43) Pub. Date: Jun. 25, 2026

(54) CONTROL DEVICE, ELECTRICAL POWER SUPPLY SYSTEM, AIRCRAFT, CONTROL METHOD, AND STORAGE MEDIUM

(71) Applicant: HONDA MOTOR CO., LTD., Tokyo (JP)

(72) Inventor: Kenta Shuto, Wako-shi (JP)

(21) Appl. No.: 19/428,797

(22) Filed: Dec. 22, 2025

(30) Foreign Application Priority Data
Dec. 25, 2024 (JP) 2024-228407

(51) Int. Cl. B64D 31/16; B64C 27/00; B64D 27/34; B64D 27/351; B64D 27/357; H02J 1/08; H02J 1/16

(52) U.S. Cl. CPC B64D 31/16; B64C 27/00; B64D 27/34; B64D 27/351; B64D 27/357; H02J 1/084; H02J 1/16; B64D 2221/00

(57) ABSTRACT

A control device includes: a first control unit capable of controlling an electrical power conversion unit in a manner so that an electrical power is supplied from a generator to at least one of an electrical power storage device or a first load device; and a determination unit that determines a residual capacity of the electrical power storage device. In response to the determination unit determining that the residual capacity of the electrical power storage device becomes greater than or equal to a first threshold value, the first control unit can execute residual capacity reduction control for reducing the residual capacity of the electrical power storage device by controlling the electrical power conversion unit in a manner so that an electrical power is supplied from the electrical power storage device to the generator.

### CROSS-REFERENCE TO RELATED APPLICATIONS

This application is based upon and claims the benefit of priority from Japanese Patent Application No. 2024-228407 filed on Dec. 25, 2024, the contents of which are incorporated herein by reference.

### BACKGROUND OF THE INVENTION

### Field of the Invention

The present disclosure relates to a control device, an electrical power supply system, an aircraft, a control method, and a storage medium.

### Description of the Related Art

JP 6557321 B2 discloses an aircraft including a generator driven by an engine.

### SUMMARY OF THE INVENTION

It is desirable to suitably manage an electrical power.

The present disclosure has the object of solving the aforementioned problem.

A first aspect of the present disclosure is characterized by a control device that controls a first electrical power generating device including an engine, a generator, and an electrical power conversion unit, the control device comprising: a first control unit configured to control the electrical power conversion unit in a manner so that an electrical power is supplied from the generator to at least one of an electrical power storage device or a first load device; and a determination unit configured to determine a residual capacity of the electrical power storage device, wherein, in response to the determination unit determining that the residual capacity of the electrical power storage device becomes greater than or equal to a first threshold value, the first control unit can execute residual capacity reduction control for reducing the residual capacity of the electrical power storage device by controlling the electrical power conversion unit in a manner so that an electrical power is supplied from the electrical power storage device to the generator.

A second aspect of the present disclosure is characterized by an electrical power supply system comprising the control device according to the first aspect; a first electrical power supply circuit configured to supply, to the first load device, an electrical power that is output from the first electrical power generating device; a second electrical power supply circuit configured to supply, to a second load device, an electrical power that is output from a second electrical power generating device; and a connection circuit including a connection device configured to connect the first electrical power supply circuit and the second electrical power supply circuit, wherein the electrical power storage device is connected to the first electrical power supply circuit in parallel with the first electrical power generating device, and the first control unit can execute the residual capacity reduction control and execute control for supplying the electrical power from the electrical power storage device to the second electrical power generating device via the connection circuit.

A third aspect of the present disclosure is characterized by an aircraft comprising the control device according to the first aspect, wherein the first control unit can execute the residual capacity reduction control before the aircraft transitions from cruise to descent.

A fourth aspect of the present disclosure is characterized by a control method for controlling a first electrical power generating device including an engine, a generator, and an electrical power conversion unit, the control method comprising: the control step of controlling the electrical power conversion unit in a manner so that an electrical power is supplied from the generator to at least one of an electrical power storage device or a first load device; and the determination step of determining a residual capacity of the electrical power storage device, wherein, in the control step, in response to determining that the residual capacity of the electrical power storage device becomes greater than or equal to a first threshold value in the determination step, residual capacity reduction control for reducing the residual capacity of the electrical power storage device can be executed by controlling the electrical power conversion unit in a manner so that an electrical power is supplied from the electrical power storage device to the generator.

A fifth aspect of the present disclosure is characterized by a non-transitory storage medium storing a program for causing a computer to execute the control method according to the fourth aspect.

According to the present disclosure, it is possible to suitably manage an electrical power.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object;

FIG. 2 is a schematic diagram of an electrical power supply system according to one embodiment;

FIG. 3 is a schematic diagram illustrating an example of a first electrical power generating device according to the one embodiment;

FIG. 4 is a schematic diagram illustrating an example of a first electrical power storage device according to the one embodiment;

FIG. 5 is a schematic diagram illustrating an example of a backflow prevention device according to the one embodiment;

FIG. 6 is a control block diagram of a control device according to the one embodiment;

FIG. 7 is a diagram showing operations of the electrical power supply system in a regenerative state according to the one embodiment;

FIG. 8 is a diagram showing operations of the electrical power supply system in a power running state according to the one embodiment;

FIG. 9 is a flowchart of an electrical power management process;

FIG. 10A is a time chart showing a generated electrical power supplied from the first electrical power generating device to a first load device, and an electrical power consumed by the first load device;

FIG. 10B is a time chart showing a charging/discharging electrical power of the first electrical power storage device;

FIG. 10C is a time chart showing an SOC of the first electrical power storage device; and

FIG. 11 is a diagram showing operations of the electrical power supply system in the power running state in another usage example of the one embodiment.

### DETAILED DESCRIPTION OF THE INVENTION

In the present disclosure, the residual capacity of an electrical power storage device is reduced in advance before a surplus electrical power is generated due to a generator generating a more electrical power than necessary. According to the present disclosure, in the case that a surplus electrical power is actually generated, the generated surplus electrical power can be received by the electrical power storage device.

### [Moving Object 10]

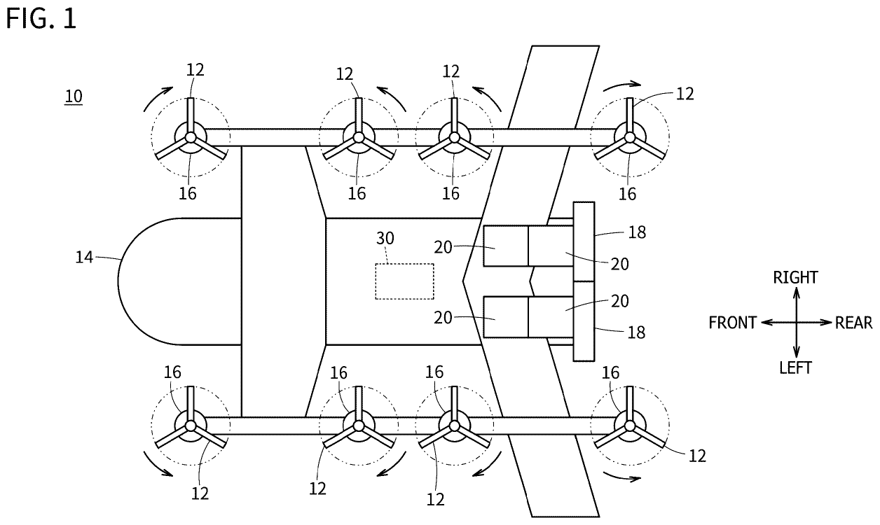

FIG. 1 is a schematic diagram of a moving object 10. The moving object 10 of one embodiment is an electric vertical take-off and landing aircraft (eVTOL aircraft). The moving object 10 is provided with eight VTOL rotors 12. The VTOL rotors 12 generate upward thrust for a fuselage 14. The moving object 10 is provided with eight electric motors 16. One of the electric motors 16 drives one of the VTOL rotors 12. The moving object 10 includes two cruise rotors 18. The cruise rotors 18 generate forward thrust for the fuselage 14. The moving object 10 is provided with four electric motors 20. Two of the electric motors 20 drive one of the cruise rotors 18. The moving object 10 is provided with an electrical power supply system 30, which will be described later. The moving object 10 is not limited to being an aircraft, but may be a ship, an automobile, a train, or the like.

### [Configuration of Electrical Power Supply System 30]

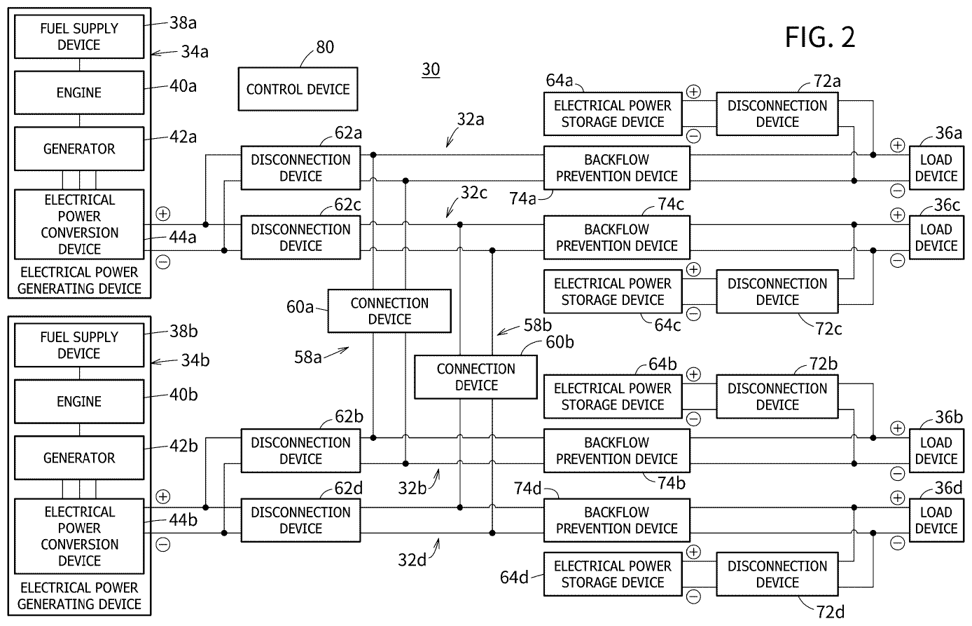

FIG. 2 is a schematic diagram of the electrical power supply system 30 according to the one embodiment. As shown in FIG. 2, the electrical power supply system 30 includes a first electrical power supply circuit 32a, a second electrical power supply circuit 32b, a third electrical power supply circuit 32c, and a fourth electrical power supply circuit 32d. The first electrical power supply circuit 32a supplies, to a first load device 36a, a DC electrical power that is output from a first electrical power generating device 34a. The second electrical power supply circuit 32b supplies, to a second load device 36b, a DC electrical power that is output from a second electrical power generating device 34b. The third electrical power supply circuit 32c supplies, to a third load device 36c, the DC electrical power that is output from the first electrical power generating device 34a. The fourth electrical power supply circuit 32d supplies, to a fourth load device 36d, the DC electrical power that is output from the second electrical power generating device 34b.

The electrical power supply system 30 is provided with the first electrical power generating device 34a and the second electrical power generating device 34b. The first electrical power generating device 34a includes a first fuel supply device 38a, a first engine 40a, a first generator 42a, and a first electrical power conversion device (an electrical power conversion unit) 44a. The second electrical power generating device 34b includes a second fuel supply device 38b, a second engine 40b, a second generator 42b, and a second electrical power conversion device 44b. The first fuel supply device 38a and the second fuel supply device 38b each include an electronically controlled injector. The first fuel supply device 38a supplies a fuel to the first engine 40a. The second fuel supply device 38b supplies a fuel to the second engine 40b. The first engine 40a and the second engine 40b, for example, are gas turbine engines. Moreover, the first engine 40a and the second engine 40b may be other engines such as reciprocating engines. The first generator 42a and the second generator 42b are motor generators that can also function as electric motors. The first electrical power conversion device 44a and the second electrical power conversion device 44b can perform electrical power conversion from a three-phase AC electrical power into a DC electrical power and electrical power conversion from a DC electrical power to a three-phase AC electrical power.

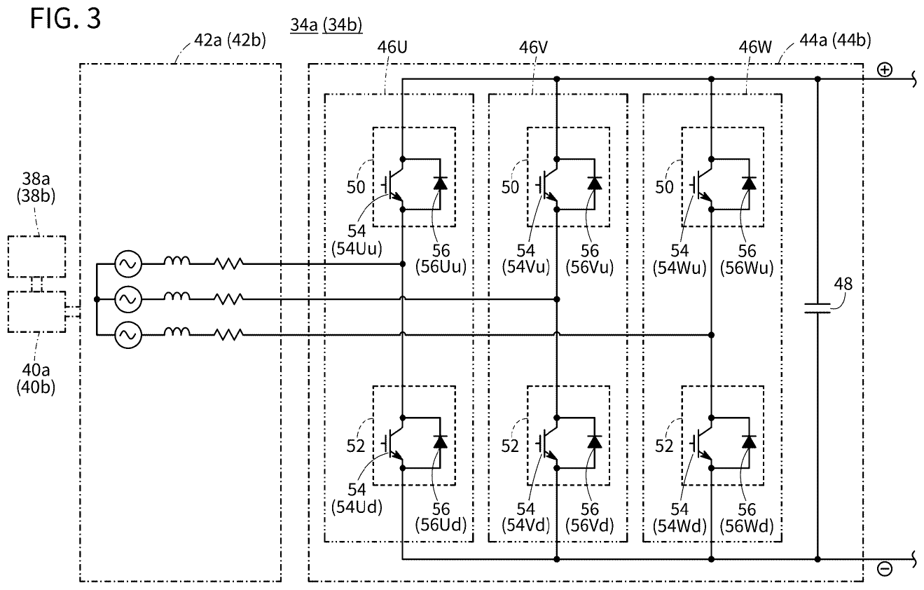

FIG. 3 is a schematic diagram illustrating an example of the first electrical power generating device 34a according to the one embodiment. The second electrical power generating device 34b has the same configuration as the first electrical power generating device 34a. As shown in FIG. 3, the first electrical power conversion device 44a provided in the first electrical power generating device 34a includes: power element units 46U, 46V, and 46 W corresponding to respective phases of the three-phase voltage output from the first generator 42a; and a smoothing capacitor 48. The power element units 46V and 46 W have the same configuration as the power element unit 46U.

The power element unit 46U includes an upper arm 50 and a lower arm 52. The upper arm 50 includes a switching element 54 (54Uu, 54Vu, 54Wu), and a diode 56 (56Uu, 56Vu, 56Wu). The lower arm 52 includes a switching element 54 (54Ud, 54Vd, 54Wd), and a diode 56 (56Ud, 56Vd, 56Wd). For example, in the power element unit 46U, the switching element 54Uu and the switching element 54Ud are connected in series to each other. That is, a first end portion of the switching element 54Uu is connected to a positive wire of the first electrical power conversion device 44a. A second end portion of the switching element 54Uu is connected to a first end portion of the switching element 54Ud. A second end portion of the switching element 54Ud is connected to a negative wire of the first electrical power conversion device 44a. The second end portion of the switching element 54Uu and the first end portion of the switching element 54Ud are connected to a terminal of the first phase (for example, the U phase) of the first generator 42a. The anode of the diode 56Uu is connected to the second end portion of the switching element 54Uu. The cathode of the diode 56Uu is connected to the first end portion of the switching element 54Uu. The anode of the diode 56Ud is connected to the second end portion of the switching element 54Ud. The cathode of the diode 56Ud is connected to the first end portion of the switching element 54Ud.

Moreover, in the power element unit 46V, a second end portion of the switching element 54Vu and a first end portion of the switching element 54Vd are connected to a terminal of the second phase (for example, the V phase) of the first generator 42a. In the power element unit 46 W, a second end portion of the switching element 54Wu and a first end portion of the switching element 54Wd are connected to a terminal of the third phase (for example, the W phase) of the first generator 42a.

Each switching element 54 is a semiconductor switch such as a metal oxide semiconductor field effect transistor (MOSFET) or an insulated gate bipolar transistor (IGBT).

The first electrical power conversion device 44a and the second electrical power conversion device 44b have a bidirectional electrical power conversion function. The first electrical power conversion device 44a and the second electrical power conversion device 44b can perform a regenerative operation and a power running operation under the control of a control device 80. Specifically, the plurality of switching elements 54 in each of the power element units 46U, 46V, and 46 W are switched between an ON-state and an OFF-state under the control of the control device 80. During the power running operation, by adjusting a time during which each of the power element units 46U, 46V, and 46 W is turned on, the magnitude and the cycle of the three-phase AC electrical power are adjusted.

During regeneration, the first generator 42a is driven by the first engine 40a and thereby generates a three-phase AC electrical power. The first electrical power conversion device 44a converts the three-phase AC electrical power that is output from the first generator 42a into a DC electrical power. Similarly, during regeneration, the second generator 42b is driven by the second engine 40b and thereby generates a three-phase AC electrical power. The second electrical power conversion device 44b converts the three-phase AC electrical power that is output from the second generator 42b into a DC electrical power.

During power running, the first electrical power conversion device 44a converts the DC electrical power that is supplied from a first electrical power storage device 64a (or another electrical power storage device) into a three-phase AC electrical power. By being supplied with the three-phase AC electrical power from the first electrical power conversion device 44a, the first generator 42a functions as an electric motor that drives the first engine 40a. Similarly, during power running, the second electrical power conversion device 44b converts the DC electrical power that is supplied from a second electrical power storage device 64b (or another electrical power storage device) into a three-phase AC electrical power. By being supplied with the three-phase AC electrical power from the second electrical power conversion device 44b, the second generator 42b functions as an electric motor that drives the second engine 40b.

The first electrical power conversion device 44a and the second electrical power conversion device 44b may each include various sensors such as a voltage sensor and a current sensor, and elements such as a fuse, a relay, a breaker, a diode, a transistor, a resistor, a coil, and a capacitor.

As shown in FIG. 2, the electrical power supply system 30 includes the first load device 36a, the second load device 36b, the third load device 36c, and the fourth load device 36d. Each of the first load device 36a, the second load device 36b, the third load device 36c, and the fourth load device 36d is provided with two electric motors 16 and one electric motor 20. An inverter is connected to each of the two electric motors 16 and the electric motor 20. The inverter converts an input DC electrical power into a three-phase AC electrical power, and the electric motors 16 (or the electric motor 20) are driven by the three-phase AC electrical power. The first load device 36a, the second load device 36b, the third load device 36c, and the fourth load device 36d may each include a non-illustrated DC/DC electrical power conversion device and a low-voltage drive device. The DC/DC electrical power conversion device causes the voltage of the input DC electrical power to be reduced, and the low-voltage drive device is driven by the DC electrical power.

The first load device 36a, the second load device 36b, the third load device 36c, and the fourth load device 36d may each include various sensors such as a voltage sensor and a current sensor, and elements such as a fuse, a relay, a breaker, a diode, a transistor, a resistor, a coil, and a capacitor. A plurality of the first load devices 36a may be connected in parallel to each other to the first electrical power supply circuit 32a. A plurality of the second load devices 36b may be connected in parallel to each other to the second electrical power supply circuit 32b. A plurality of the third load devices 36c may be connected in parallel to each other to the third electrical power supply circuit 32c. A plurality of the fourth load devices 36d may be connected in parallel to each other to the fourth electrical power supply circuit 32d.

The electrical power supply system 30 is provided with a first connection circuit 58a and a second connection circuit 58b. The first connection circuit 58a is provided with a first connection device 60a. The second connection circuit 58b is provided with a second connection device 60b.

The first connection device 60a is capable of connecting the first electrical power supply circuit 32a and the second electrical power supply circuit 32b. The first connection device 60a is switched, by a non-illustrated contactor, between a state in which the first electrical power supply circuit 32a and the second electrical power supply circuit 32b are connected, and a state in which the first electrical power supply circuit 32a and the second electrical power supply circuit 32b are disconnected.

Similarly, the second connection device 60b is capable of connecting the third electrical power supply circuit 32c and the fourth electrical power supply circuit 32d. The second connection device 60b is switched, by a non-illustrated contactor, between a state in which the third electrical power supply circuit 32c and the fourth electrical power supply circuit 32d are connected, and a state in which the third electrical power supply circuit 32c and the fourth electrical power supply circuit 32d are disconnected.

The first connection device 60a and the second connection device 60b may each include a relay instead of the contactor. The first connection device 60a and the second connection device 60b may each include a breaker instead of the contactor. The first connection device 60a and the second connection device 60b may each include a semiconductor switch instead of the contactor.

Normally, the first electrical power supply circuit 32a and the second electrical power supply circuit 32b are disconnected. In accordance with this feature, in the case that an abnormality has occurred in one of the first electrical power supply circuit 32a or the second electrical power supply circuit 32b, it is possible to prevent the abnormality from adversely influencing the other one. For example, in the case that an excessive electrical current has been generated in one of the first electrical power supply circuit 32a or the second electrical power supply circuit 32b, it is possible to prevent the excessive electrical current from flowing to the other one.

In the same manner, normally, the third electrical power supply circuit 32c and the fourth electrical power supply circuit 32d are disconnected. In accordance with this feature, in the case that an abnormality has occurred in one of the third electrical power supply circuit 32c or the fourth electrical power supply circuit 32d, it is possible to prevent the abnormality from adversely influencing the other one. For example, in the case that an excessive electrical current has been generated in one of the third electrical power supply circuit 32c or the fourth electrical power supply circuit 32d, it is possible to prevent the excessive electrical current from flowing to the other one.

In the case that a problem has occurred in the supply of the electrical power from the first electrical power generating device 34a to the first electrical power supply circuit 32a, the first electrical power supply circuit 32a and the second electrical power supply circuit 32b are connected by the first connection device 60a. In accordance with this feature, the electrical power is supplied from the second electrical power supply circuit 32b to the first electrical power supply circuit 32a.

In the case that a problem has occurred in the supply of the electrical power from the first electrical power generating device 34a to the third electrical power supply circuit 32c, the third electrical power supply circuit 32c and the fourth electrical power supply circuit 32d are connected by the second connection device 60b. In accordance with this feature, the electrical power is supplied from the fourth electrical power supply circuit 32d to the third electrical power supply circuit 32c.

In the case that a problem has occurred in the supply of the electrical power from the second electrical power generating device 34b to the second electrical power supply circuit 32b, the first electrical power supply circuit 32a and the second electrical power supply circuit 32b are connected by the first connection device 60a. In accordance with this feature, the electrical power is supplied from the first electrical power supply circuit 32a to the second electrical power supply circuit 32b.

In the case that a problem has occurred in the supply of the electrical power from the second electrical power generating device 34b to the fourth electrical power supply circuit 32d, the third electrical power supply circuit 32c and the fourth electrical power supply circuit 32d are connected by the second connection device 60b. In accordance with this feature, the electrical power is supplied from the third electrical power supply circuit 32c to the fourth electrical power supply circuit 32d.

The electrical power supply system 30 is provided with disconnection devices 62a to 62d. The disconnection device 62a is capable of disconnecting the first electrical power generating device 34a from the first electrical power supply circuit 32a and the first connection circuit 58a. The disconnection device 62b is capable of disconnecting the second electrical power generating device 34b from the second electrical power supply circuit 32b and the first connection circuit 58a. The disconnection device 62c is capable of disconnecting the first electrical power generating device 34a from the third electrical power supply circuit 32c and the second connection circuit 58b. The disconnection device 62d is capable of disconnecting the second electrical power generating device 34b from the fourth electrical power supply circuit 32d and the second connection circuit 58b.

The disconnection device 62a is switched, by a non-illustrated contactor, between a state in which the first electrical power generating device 34a is disconnected from the first electrical power supply circuit 32a and the first connection circuit 58a, and a state in which the first electrical power generating device 34a is connected to the first electrical power supply circuit 32a and the first connection circuit 58a. Similarly, the disconnection device 62b is switched, by a non-illustrated contactor, between a state in which the second electrical power generating device 34b is disconnected from the second electrical power supply circuit 32b and the first connection circuit 58a, and a state in which the second electrical power generating device 34b is connected to the second electrical power supply circuit 32b and the first connection circuit 58a.

Further, the disconnection device 62c is switched, by a non-illustrated contactor, between a state in which the first electrical power generating device 34a is disconnected from the third electrical power supply circuit 32c and the second connection circuit 58b, and a state in which the first electrical power generating device 34a is connected to the third electrical power supply circuit 32c and the second connection circuit 58b. Similarly, the disconnection device 62d is switched, by a non-illustrated contactor, between a state in which the second electrical power generating device 34b is disconnected from the fourth electrical power supply circuit 32d and the second connection circuit 58b, and a state in which the second electrical power generating device 34b is connected to the fourth electrical power supply circuit 32d and the second connection circuit 58b.

The disconnection devices 62a to 62d may each include a relay instead of the contactor. The disconnection devices 62a to 62d may each include a breaker instead of the contactor. The disconnection devices 62a to 62d may each include a semiconductor switch instead of the contactor.

The electrical power supply system 30 is provided with the first electrical power storage device 64a, the second electrical power storage device 64b, a third electrical power storage device 64c, and a fourth electrical power storage device 64d. The first electrical power storage device 64a is connected to the first electrical power supply circuit 32a in parallel with the first electrical power generating device 34a. The second electrical power storage device 64b is connected to the second electrical power supply circuit 32b in parallel with the second electrical power generating device 34b. The third electrical power storage device 64c is connected to the third electrical power supply circuit 32c in parallel with the first electrical power generating device 34a. The fourth electrical power storage device 64d is connected to the fourth electrical power supply circuit 32d in parallel with the second electrical power generating device 34b.

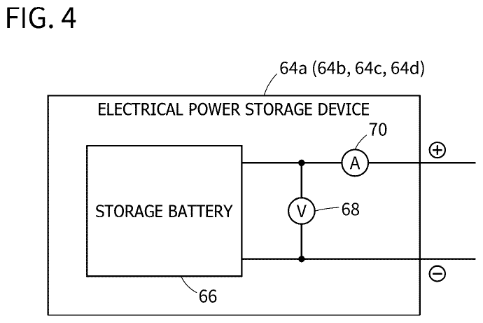

FIG. 4 is a schematic diagram illustrating an example of the first electrical power storage device 64a according to the one embodiment. As shown in FIG. 4, the second electrical power storage device 64b, the third electrical power storage device 64c, and the fourth electrical power storage device 64d have the same configuration as the first electrical power storage device 64a. The first electrical power storage device 64a includes a storage battery 66. The storage battery 66 may be, for example, a lithium ion battery or another type of battery. The first electrical power storage device 64a, the second electrical power storage device 64b, the third electrical power storage device 64c, and the fourth electrical power storage device 64d may each include a large-capacity capacitor instead of the storage battery 66.

The first electrical power storage device 64a includes a voltage sensor 68 and an electrical current sensor 70. The voltage sensor 68 is connected to a positive terminal and a negative terminal of the storage battery 66. The voltage sensor 68 measures a potential difference between the terminals of the storage battery 66. The electrical current sensor 70 is disposed on a positive wire that is connected to the positive terminal of the storage battery 66 or on a negative wire that is connected to the negative terminal of the storage battery 66. The electrical current sensor 70 measures the electrical current that flows through the positive wire or the negative wire.

The first electrical power storage device 64a, the second electrical power storage device 64b, the third electrical power storage device 64c, and the fourth electrical power storage device 64d may each include various other sensors, and elements such as a fuse, a relay, a breaker, a diode, a transistor, a resistor, a coil, and a capacitor.

As shown in FIG. 2, the electrical power supply system 30 is provided with disconnection devices 72a to 72d. The disconnection device 72a is capable of disconnecting the first electrical power storage device 64a from the first electrical power supply circuit 32a and the first load device 36a. The disconnection device 72b is capable of disconnecting the second electrical power storage device 64b from the second electrical power supply circuit 32b and the second load device 36b. The disconnection device 72c is capable of disconnecting the third electrical power storage device 64c from the third electrical power supply circuit 32c and the third load device 36c. The disconnection device 72d is capable of disconnecting the fourth electrical power storage device 64d from the fourth electrical power supply circuit 32d and the fourth load device 36d.

The disconnection device 72a is switched, by a non-illustrated contactor, between a state in which the first electrical power storage device 64a is disconnected from the first electrical power supply circuit 32a and the first load device 36a, and a state in which the first electrical power storage device 64a is connected to the first electrical power supply circuit 32a and the first load device 36a. Similarly, the disconnection device 72b is switched, by a non-illustrated contactor, between a state in which the second electrical power storage device 64b is disconnected from the second electrical power supply circuit 32b and the second load device 36b, and a state in which the second electrical power storage device 64b is connected to the second electrical power supply circuit 32b and the second load device 36b.

Further, the disconnection device 72c is switched, by a non-illustrated contactor, between a state in which the third electrical power storage device 64c is disconnected from the third electrical power supply circuit 32c and the third load device 36c, and a state in which the third electrical power storage device 64c is connected to the third electrical power supply circuit 32c and the third load device 36c. Similarly, the disconnection device 72d is switched, by a non-illustrated contactor, between a state in which the fourth electrical power storage device 64d is disconnected from the fourth electrical power supply circuit 32d and the fourth load device 36d, and a state in which the fourth electrical power storage device 64d is connected to the fourth electrical power supply circuit 32d and the fourth load device 36d.

The disconnection devices 72a to 72d may each include a relay instead of the contactor. The disconnection devices 72a to 72d may each include a breaker instead of the contactor. The disconnection devices 72a to 72d may each include a semiconductor switch instead of the contactor.

The electrical power supply system 30 is provided with backflow prevention devices 74a to 74d. The backflow prevention device 74a limits the supply of the electrical power from the first electrical power storage device 64a to the first electrical power supply circuit 32a and the first electrical power generating device 34a. The backflow prevention device 74b limits the supply of the electrical power from the second electrical power storage device 64b to the second electrical power supply circuit 32b and the second electrical power generating device 34b. The backflow prevention device 74c limits the supply of the electrical power from the third electrical power storage device 64c to the third electrical power supply circuit 32c and the first electrical power generating device 34a. The backflow prevention device 74d limits the supply of the electrical power from the fourth electrical power storage device 64d to the fourth electrical power supply circuit 32d and the second electrical power generating device 34b.

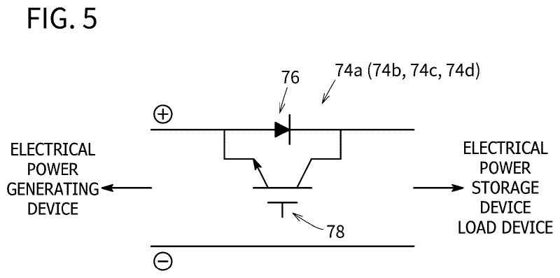

FIG. 5 is a schematic diagram illustrating an example of the backflow prevention device 74a according to the one embodiment. As shown in FIG. 5, the backflow prevention devices 74b to 74d have the same configuration as the backflow prevention device 74a. The backflow prevention device 74a includes, for example, a diode 76 and a transistor 78.

The diode 76 is provided in a positive wire. In the case that the voltage of the anode is lower than the voltage of the cathode, almost no electrical current flows through the diode 76. In the case that the voltage of the anode has become higher than the voltage of the cathode by more than the forward voltage, an electrical current flows through the diode 76. In accordance with this feature, an electrical power is supplied via the diode 76 from the first electrical power generating device 34a to the first load device 36a and the first electrical power storage device 64a.

The transistor 78 is disposed so as to bypass the diode 76. In the case that an electrical current flows from the base to the emitter of the transistor 78, the electrical current flows from the collector to the emitter. In accordance with this feature, the electrical power becomes capable of being supplied via the first electrical power supply circuit 32a from the first electrical power storage device 64a to the first connection circuit 58a. The diode 76 may be provided in a negative wire. Further, the diode 76 may be provided in both the positive wire and the negative wire.

Moreover, the backflow prevention device 74a may be provided with only the diode 76, and may not be provided with the transistor 78. Further, the backflow prevention device 74a may also include a switching device such as a contactor. The contactor is disposed in at least one of the positive wire or the negative wire.

In addition to the configuration described above, the electrical power supply system 30 may include various sensors such as a voltage sensor and a current sensor, and elements such as a fuse, a resistor, a coil, and a capacitor.

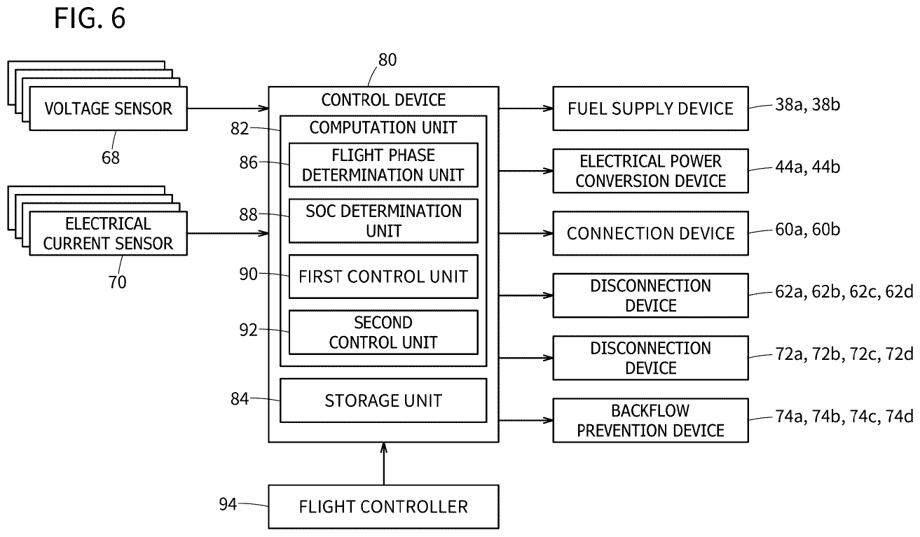

FIG. 6 is a control block diagram of the control device 80 according to the one embodiment. The electrical power supply system 30 is provided with the control device 80. The control device 80 controls the first electrical power conversion device 44a, the second electrical power conversion device 44b, the first connection device 60a, the second connection device 60b, the disconnection devices 62a to 62d, the disconnection devices 72a to 72d, and the backflow prevention devices 74a to 74d.

The control device 80 includes a computation unit 82 and a storage unit 84. The computation unit 82 is a processor such as a central processing unit (CPU) or a graphics processing unit (GPU). The computation unit 82 includes a flight phase determination unit 86, an SOC determination unit 88, a first control unit 90, and a second control unit 92. The flight phase determination unit 86, the SOC determination unit 88, the first control unit 90, and the second control unit 92 are realized by the computation unit 82 executing a program stored in the storage unit 84. At least a portion of the flight phase determination unit 86, the SOC determination unit 88, the first control unit 90, and the second control unit 92 may be realized by an integrated circuit such as an application specific integrated circuit (ASIC) or a field-programmable gate array (FPGA). At least a portion of the flight phase determination unit 86, the SOC determination unit 88, the first control unit 90, and the second control unit 92 may be realized by an electronic circuit including a discrete device.

The storage unit 84 is a computer-readable non-transitory tangible storage medium. The storage unit 84 is constituted by a non-illustrated volatile memory and a non-illustrated non-volatile memory. The volatile memory, for example, is a random access memory (RAM) or the like. The non-volatile memory is, for example, a read only memory (ROM), a flash memory, or the like. Data and the like are stored in, for example, the volatile memory. A program, a table, a map, and the like are stored, for example, in the non-volatile memory. At least a portion of the storage unit 84 may be provided in the processor, the integrated circuit, or the like described above.

The flight phase determination unit 86 determines which of all the phases of the moving object 10 the current flight phase is. The flight phase of the moving object 10 includes a take-off phase, a cruise phase, and a landing phase. The take-off phase includes a vertical take-off phase in which the moving object 10 climbs substantially vertically upward, and a climb phase in which the moving object 10 climbs to a cruising altitude while accelerating in the horizontal direction. A first stopping phase (hovering) may be included between the vertical take-off phase and the climb phase. The landing phase includes a descent phase in which the moving object 10 descends from the cruising altitude to a predetermined altitude while decelerating in the horizontal direction, and a vertical landing phase in which the moving object 10 descends substantially vertically downward. A second stopping phase (hovering) may be included between the descent phase and the vertical landing phase. The flight phase determination unit 86 acquires information indicating the current flight phase (referred to as flight information) from, for example, a flight controller 94 that manages the overall control of the moving object 10.

The SOC determination unit 88 determines the residual capacity of each of the electrical power storage devices (the first electrical power storage device 64a to the fourth electrical power storage device 64d). The residual capacity of the electrical power storage device is also referred to herein as a state of charge (SOC). The SOC determination unit 88 periodically determines the SOC of the electrical power storage device by, for example, an electrical current integration method that is based on an electrical current value detected by the electrical current sensor 70. The latest (current) SOC determined by the SOC determination unit 88 is referred to herein as SOC_L.

The first control unit 90 executes switching control of the switching elements 54 provided in the first electrical power conversion device 44a and the switching elements 54 provided in the second electrical power conversion device 44b. The first control unit 90 is capable of controlling the plurality of switching elements 54 based on a switching pattern corresponding to each of the regeneration and the power running. Further, the first control unit 90 executes an opening and closing control (an ON/OFF control) of the first connection device 60a, the second connection device 60b, the disconnection devices 62a to 62d, the disconnection devices 72a to 72d, and the transistors 78 of the backflow prevention devices 74a to 74d.

The second control unit 92 can limit an amount of the fuel supplied to the first engine 40a and the second engine 40b by controlling the injector provided in the first fuel supply device 38a and the injector provided in the second fuel supply device 38b.

[Operations of Electrical Power Supply System 30 in Regenerative State]

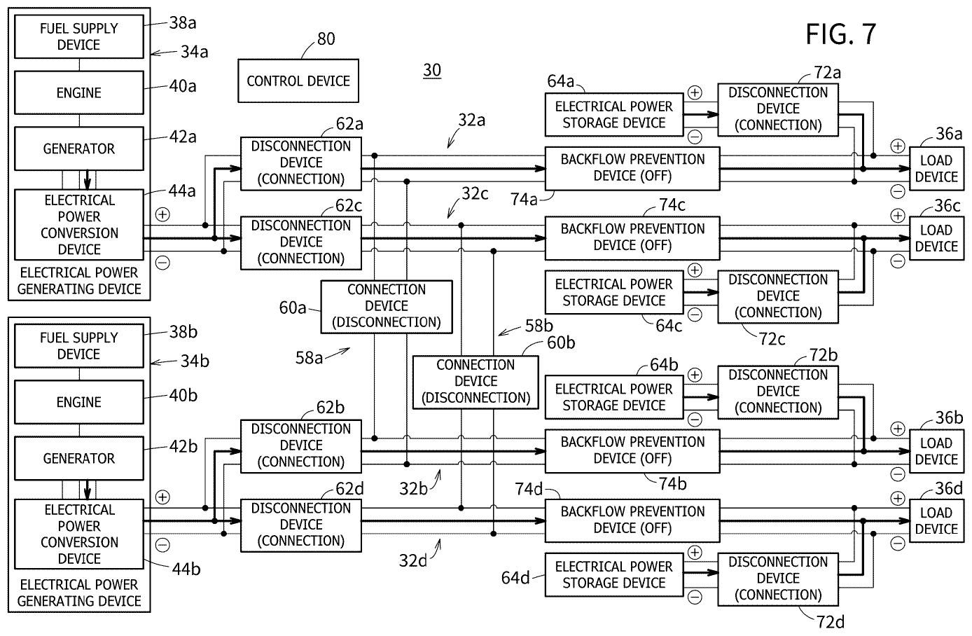

FIG. 7 is a diagram showing operations of the electrical power supply system 30 in a regenerative state according to the one embodiment. FIG. 7 shows the operations of the electrical power supply system 30 at a normal time. The arrows shown in FIG. 7 indicate electrical power supply pathways.

As shown in FIG. 7, the first electrical power generating device 34a is connected to the first electrical power supply circuit 32a by the disconnection device 62a, and the first electrical power generating device 34a is connected to the third electrical power supply circuit 32c by the disconnection device 62c. In accordance with this feature, the three-phase AC electrical power that is output from the first generator 42a is converted into a DC electrical power by the first electrical power conversion device 44a, and the DC electrical power is supplied to the first load device 36a and the third load device 36c.

The second electrical power generating device 34b is connected to the second electrical power supply circuit 32b by the disconnection device 62b, and the second electrical power generating device 34b is connected to the fourth electrical power supply circuit 32d by the disconnection device 62d. In accordance with this feature, the three-phase AC electrical power that is output from the second generator 42b is converted into a DC electrical power by the second electrical power conversion device 44b, and the DC electrical power is supplied to the second load device 36b and the fourth load device 36d.

The first electrical power storage device 64a is connected to the first load device 36a by the disconnection device 72a. In accordance with this feature, the DC electrical power that is output from the first electrical power storage device 64a is supplied to the first load device 36a. The second electrical power storage device 64b is connected to the second load device 36b by the disconnection device 72b. In accordance with this feature, the DC electrical power that is output from the second electrical power storage device 64b is supplied to the second load device 36b. The third electrical power storage device 64c is connected to the third load device 36c by the disconnection device 72c. In accordance with this feature, the DC electrical power that is output from the third electrical power storage device 64c is supplied to the third load device 36c. The fourth electrical power storage device 64d is connected to the fourth load device 36d by the disconnection device 72d. In accordance with this feature, the DC electrical power that is output from the fourth electrical power storage device 64d is supplied to the fourth load device 36d.

At a normal time, the first electrical power supply circuit 32a and the second electrical power supply circuit 32b are disconnected by the first connection device 60a, and the third electrical power supply circuit 32c and the fourth electrical power supply circuit 32d are disconnected by the second connection device 60b.

When an abnormality occurs in the first electrical power generating device 34a or the second electrical power generating device 34b, the first electrical power supply circuit 32a and the second electrical power supply circuit 32b can be connected by the first connection device 60a. Similarly, when an abnormality or the like occurs in the first electrical power generating device 34a or the second electrical power generating device 34b, the third electrical power supply circuit 32c and the fourth electrical power supply circuit 32d can be connected by the second connection device 60b. In accordance with this feature, the three-phase AC electrical power that is output from the first generator 42a is converted into a DC electrical power by the first electrical power conversion device 44a, and the DC electrical power can be supplied to the second load device 36b and the fourth load device 36d. Alternatively, the three-phase AC electrical power that is output from the second generator 42b is converted into a DC electrical power by the second electrical power conversion device 44b, and the DC electrical power can be supplied to the first load device 36a and the third load device 36c.

### [Operations of Electrical Power Supply System 30 in Power Running State]

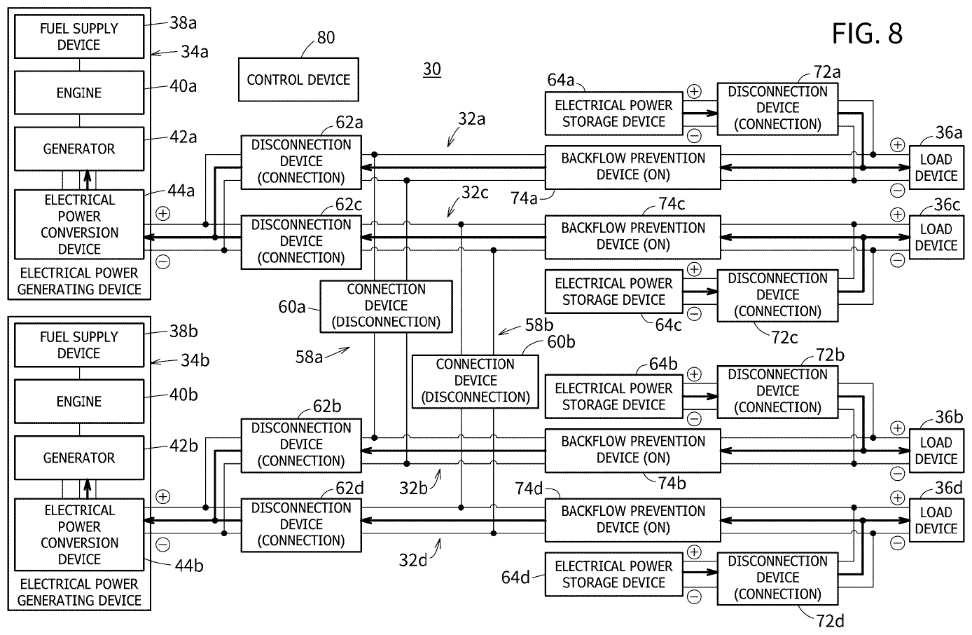

FIG. 8 is a diagram showing operations of the electrical power supply system 30 in a power running state according to the one embodiment. The arrows shown in FIG. 8 indicate electrical power supply pathways.

The first control unit 90 of the control device 80 transmits an ON signal to the transistor 78 provided in each of the backflow prevention devices 74a and 74c. Then, in each transistor 78, the electrical current can flow from the base to the emitter and the electrical current can flow from the collector to the emitter. In the case that the potential of the first electrical power storage device 64a is higher than the potential of the first electrical power generating device 34a, the DC electrical power that is output from the first electrical power storage device 64a is converted into a three-phase AC electrical power by the first electrical power conversion device 44a and the three-phase AC electrical power is supplied to the first generator 42a. The DC electrical power that is output from the first electrical power storage device 64a is also supplied to the first load device 36a. In the case that the potential of the third electrical power storage device 64c is higher than the potential of the first electrical power generating device 34a, the DC electrical power that is output from the third electrical power storage device 64c is converted into a three-phase AC electrical power by the first electrical power conversion device 44a and the three-phase AC electrical power is supplied to the first generator 42a. The DC electrical power that is output from the third electrical power storage device 64c is also supplied to the third load device 36c.

The first control unit 90 of the control device 80 transmits an ON signal to the transistor 78 provided in each of the backflow prevention devices 74b and 74d. Then, in each transistor 78, the electrical current can flow from the base to the emitter and the electrical current can flow from the collector to the emitter. In the case that the potential of the second electrical power storage device 64b is higher than the potential of the second electrical power generating device 34b, the DC electrical power that is output from the second electrical power storage device 64b is converted into a three-phase AC electrical power by the second electrical power conversion device 44b and the three-phase AC electrical power is supplied to the second generator 42b. The DC electrical power that is output from the second electrical power storage device 64b is also supplied to the second load device 36b. In the case that the potential of the fourth electrical power storage device 64d is higher than the potential of the second electrical power generating device 34b, the DC electrical power that is output from the fourth electrical power storage device 64d is converted into a three-phase AC electrical power by the second electrical power conversion device 44b and the three-phase AC electrical power is supplied to the second generator 42b. The DC electrical power that is output from the fourth electrical power storage device 64d is also supplied to the fourth load device 36d.

### [Electrical Power Management Process]

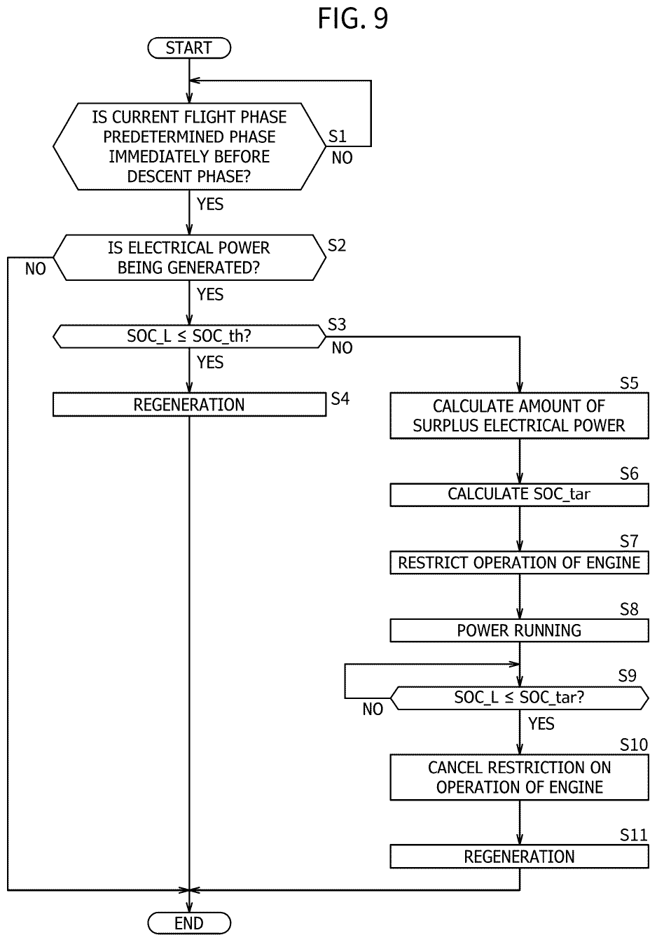

FIG. 9 is a flowchart of an electrical power management process. In this instance, a process of managing a generated electrical power of the first electrical power generating device 34a and a charging/discharging electrical power of the first electrical power storage device 64a will be described.

In step S1, the flight phase determination unit 86 determines the current flight phase of the moving object 10 based on flight information acquired from the flight controller 94. The timings at which the processes after step S2 are performed are determined in advance. The processes after step S2 are performed in a predetermined phase in the cruise phase, the predetermined phase being immediately before the descent phase. In the case that the current flight phase is the predetermined phase in the cruise phase (step S1: YES), the process transitions to step S2. On the other hand, in the case that the current flight phase is other than the predetermined phase in the cruise phase (step S1: NO), the determination of step S1 is executed again.

When the process transitions from step S1 to step S2, the first control unit 90 determines whether or not the first electrical power generating device 34a is generating an electrical power. In the case that the first electrical power generating device 34a is generating the electrical power (step S2: YES), the process transitions to step S3. On the other hand, in the case that the first electrical power generating device 34a is not generating the electrical power (step S2: NO), the electrical power management process is ended.

When the process transitions from step S2 to step S3, the SOC determination unit 88 compares the SOC_L, which is the current SOC of the first electrical power storage device 64a, with SOC_th (a first threshold value). The SOC_th is, for example, an upper limit threshold value of a recommended range (an allowable range or the like) of the SOC. Moreover, the SOC_th is not limited to this feature, and can be set to any value. The SOC_th is stored in advance in the storage unit 84. In the case that SOC_L≤SOC_th is satisfied (step S3: YES), the process transitions to step S4. In this case, since the SOC of the first electrical power storage device 64a is relatively low, the first electrical power storage device 64a can receive the surplus electrical power generated by the first electrical power generating device 34a. On the other hand, in the case that SOC_L>SOC_th is satisfied (step S3: NO), the process transitions to step S5. In this case, since the SOC of the first electrical power storage device 64a is high, the first electrical power storage device 64a cannot receive the surplus electrical power generated by the first electrical power generating device 34a.

When the process transitions from step S3 to step S4, the first control unit 90 and the second control unit 92 execute control so that the electrical power supply system 30 is brought into a regenerative state. For example, the first control unit 90 controls respective parts so that the electrical power supply system 30 is brought into a state as shown in FIG. 7. At this time, the first control unit 90 controls the switching elements 54 provided in the first electrical power conversion device 44a so that the DC electrical power is supplied from the first generator 42a to at least one of the first electrical power storage device 64a or the first load device 36a. Further, the second control unit 92 controls the first fuel supply device 38a so that the first engine 40a maintains the rotational speed equal to or higher than a target value. The electrical power management process is thus ended.

When the process transitions from step S3 to step S5, the first control unit 90 executes SOC reduction control (residual capacity reduction control) for reducing the SOC of the first electrical power storage device 64a. Specifically, the first control unit 90 executes the processes of step S5, step S6, and step S8.

In step S5, the first control unit 90 calculates (estimates) an amount of surplus electrical power generated during the descent phase. In the descent phase, the moving object 10 glides. During gliding of the moving object 10, the electric motors 16 and 20 provided in the first load device 36a are stopped. On the other hand, even when the moving object 10 is gliding, the first engine 40a is operating. Therefore, the electrical power generated by the first electrical power generating device 34a becomes a surplus electrical power. The surplus electrical power is mainly supplied to the first electrical power storage device 64a. The first control unit 90 calculates an amount of surplus electrical power generated during gliding. For example, the first control unit 90 calculates the amount of surplus electrical power (the amount of electrical power generated by the first generator 42a), based on information such as the time required for the descent phase and the rotational speed of the first engine 40a during the descent phase.

In step S6, the first control unit 90 calculates SOC_tar (a second threshold value). The SOC_tar is a target value of the SOC of the first electrical power storage device 64a in the SOC reduction control. The first control unit 90 calculates the SOC_tar based on the amount of surplus electrical power calculated in step S5, and the SOC_th.

In step S7, the second control unit 92 restricts the operation of the first engine 40a. The second control unit 92 controls the first fuel supply device 38a to limit the fuel that is supplied to the first engine 40a. The rotational speed of the first engine 40a after the limiting of the fuel becomes lower than the rotational speed of the first engine 40a in the regenerative state.

In step S8, the first control unit 90 executes control so that the electrical power supply system 30 is brought into a power running state. For example, the first control unit 90 controls respective parts so that the electrical power supply system 30 is brought into a state as shown in FIG. 8. At this time, the first control unit 90 controls the switching elements 54 provided in the first electrical power conversion device 44a so that an electrical power is supplied from the first electrical power storage device 64a to the first generator 42a.

In step S9, the SOC determination unit 88 compares the SOC_L, which is the current SOC of the first electrical power storage device 64a, with the SOC_tar, which is the target value of the SOC of the first electrical power storage device 64a. In the case that SOC_L≤SOC_tar is satisfied (step S9: YES), the process transitions to step S10. In this case, the SOC of the first electrical power storage device 64a has been reduced to a level such that the first electrical power storage device 64a can receive the surplus electrical power estimated to be generated until the descent phase is completed. On the other hand, in the case that SOC_L>SOC_tar is satisfied (step S9: NO), the determination of step S9 is executed again.

In step S10, the second control unit 92 cancels the restriction on the operation of the first engine 40a. The second control unit 92 increases the fuel that is supplied to the first engine 40a. As a result, the rotational speed of the first engine 40a increases.

In step S11, the first control unit 90 executes control so that the electrical power supply system 30 is brought into the regenerative state. For example, the first control unit 90 controls respective parts so that the electrical power supply system 30 is brought into a state as shown in FIG. 7. At this time, the first control unit 90 controls the switching elements 54 provided in the first electrical power conversion device 44a so that the DC electrical power is supplied from the first generator 42a to at least one of the first electrical power storage device 64a or the first load device 36a. The electrical power management process is thus ended.

[Comparison Between Case where SOC Reduction Control is Executed and Case where SOC Reduction Control is not Executed]

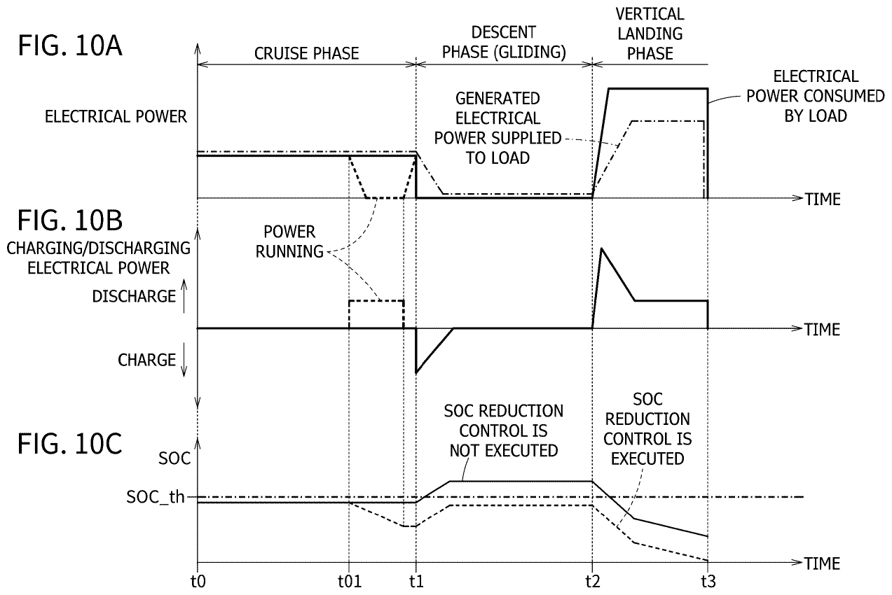

FIG. 10A is a time chart showing a generated electrical power supplied from the first electrical power generating device 34a to the first load device 36a, and an electrical power consumed by the first load device 36a. FIG. 10B is a time chart showing a charging/discharging electrical power of the first electrical power storage device 64a. FIG. 10C is a time chart showing the SOC of the first electrical power storage device 64a.

In FIG. 10A to FIG. 10C, the flight phase of the moving object 10 from a point in time to to a point in time t1 is a cruise phase. The flight phase of the moving object 10 from the point in time t1 to a point in time t2 is a descent phase. The flight phase of the moving object 10 from the point in time t2 to a point in time t3 is a vertical landing phase.

In the case that the Soc reduction control is not executed, the following situation occurs. At the point in time t1, which is the timing of transition from the cruise phase to the descent phase, the moving object 10 starts gliding. At this time, the electrical power consumed by the electric motors 16 and 20 of the first load device 36a becomes zero. In accordance therewith, the electrical power generation amount of the first generator 42a is suppressed. However, the first electrical power generating device 34a continues to generate an electrical power until the electrical power generation amount of the first generator 42a is reduced to a target value. The electrical power generated by the first electrical power generating device 34a becomes a surplus electrical power. The surplus electrical power is supplied to the first electrical power storage device 64a. If the surplus electrical power is supplied to the first electrical power storage device 64a in a state where the SOC of the first electrical power storage device 64a is close to the SOC_th, the SOC of the first electrical power storage device 64a exceeds the SOC_th. As a result, the first electrical power storage device 64a is overcharged.

On the other hand, in the case that the SOC reduction control is executed, overcharging of the first electrical power storage device 64a can be suppressed as follows. At a point in time t01 during the cruise phase (during a predetermined period), the first control unit 90 starts the SOC reduction control. That is, the first control unit 90 causes the state of the electrical power supply system 30 to transition from the regenerative state to the power running state. Then, as shown by the broken line in FIG. 10B, the first electrical power storage device 64a is discharged. At this time, the DC electrical power is supplied from the first electrical power storage device 64a to the first generator 42a and the first load device 36a. As a result, the SOC of the first electrical power storage device 64a is reduced as indicated by the broken line in FIG. 10C.

After the point in time t01 and before the point in time t1, the first control unit 90 ends the SOC reduction control. That is, the first control unit 90 causes the state of the electrical power supply system 30 to transition from the power running state to the regenerative state. At this point in time, the SOC of the first electrical power storage device 64a has been sufficiently reduced. Therefore, even if the electrical power (the surplus electrical power) generated by the first electrical power generating device 34a after the point in time t1 is supplied to the first electrical power storage device 64a, a situation is suppressed in which the SOC of the first electrical power storage device 64a exceeds the SOC_th.

In the present present embodiment, the first control unit 90 reduces the SOC of the first electrical power storage device 64a in advance before a surplus electrical power is generated due to the first generator 42a generating a more electrical power than necessary. According to the present embodiment, in the case that a surplus electrical power is generated, the generated surplus electrical power can be received by the first electrical power storage device 64a.

Further, in the present embodiment, when reducing the SOC of the first electrical power storage device 64a, the first control unit 90 causes the first generator 42a to operate as an electric motor by supplying the electrical power from the first electrical power storage device 64a to the first generator 42a. According to the present embodiment, even if the fuel that is supplied to the first engine 40a is reduced, it is possible to suppress engine stall of the first engine 40a.

### [Other Usage Example]

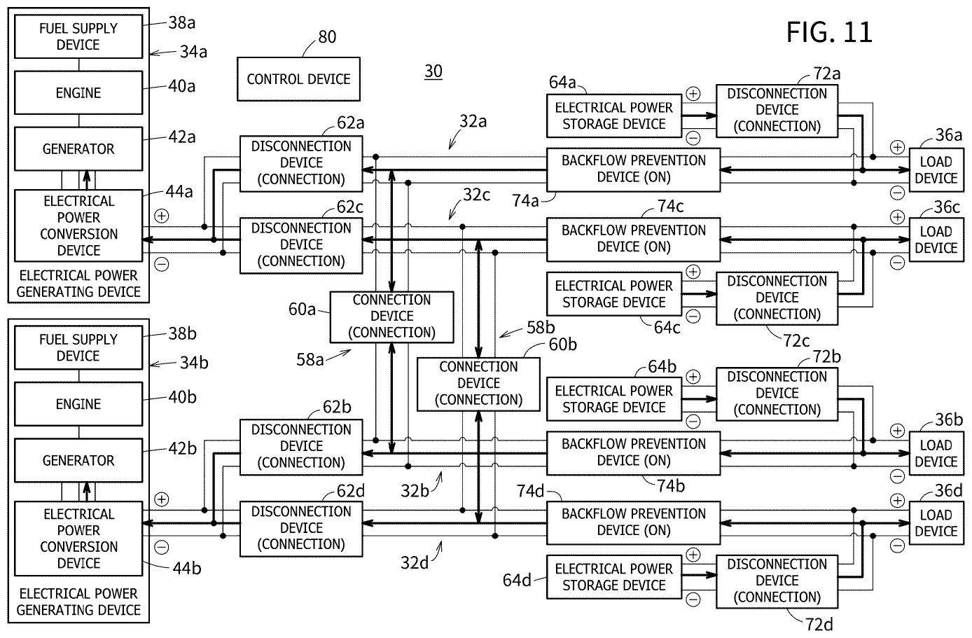

FIG. 11 is a diagram showing operations of the electrical power supply system 30 in the power running state in another usage example of the one embodiment. The arrows shown in FIG. 11 indicate electrical power supply pathways.

As shown in FIG. 11, in the case that the state of the electrical power supply system 30 is the power running state, the first control unit 90 may bring the first connection device 60a into a connecting state. In accordance with this feature, the first electrical power storage device 64a can supply the electrical power to the second generator 42b via the first connection circuit 58a. Alternatively, the second electrical power storage device 64b can supply the electrical power to the first generator 42a via the first connection circuit 58a.

The first electrical power storage device 64a supplies the electrical power to the first generator 42a and the second generator 42b, whereby the SOC of the first electrical power storage device 64a can be quickly reduced. Similarly, the second electrical power storage device 64b supplies the electrical power to the first generator 42a and the second generator 42b, whereby the SOC of the second electrical power storage device 64b can be quickly reduced.

As shown in FIG. 11, in the case that the state of the electrical power supply system 30 is the power running state, the first control unit 90 may bring the second connection device 60b into a connecting state. In accordance with this feature, the third electrical power storage device 64c can supply the electrical power to the second generator 42b via the second connection circuit 58b. Alternatively, the fourth electrical power storage device 64d can supply the electrical power to the first generator 42a via the second connection circuit 58b.

The third electrical power storage device 64c supplies the electrical power to the first generator 42a and the second generator 42b, whereby the SOC of the third electrical power storage device 64c can be quickly reduced. Similarly, the fourth electrical power storage device 64d supplies the electrical power to the first generator 42a and the second generator 42b, whereby the SOC of the fourth electrical power storage device 64d can be quickly reduced.

### [Supplementary Note]

The following supplementary notes are further disclosed in relation to the above-described embodiment.

### Supplementary Note 1

The control device (80) of the present disclosure is a control device that controls the first electrical power generating device (34a) including the engine (40a), the generator (42a), and the electrical power conversion unit (44a), the control device including: the first control unit (90) configured to control the electrical power conversion unit in a manner so that an electrical power is supplied from the generator to at least one of the electrical power storage device (64a) or the first load device (36a); and the determination unit (88) configured to determine the residual capacity (SOC_L) of the electrical power storage device, wherein, in response to the determination unit determining that the residual capacity of the electrical power storage device becomes greater than or equal to the first threshold value (SOC_th), the first control unit can execute the residual capacity reduction control for reducing the residual capacity of the electrical power storage device by controlling the electrical power conversion unit in a manner so that an electrical power is supplied from the electrical power storage device to the generator.

According to the above configuration, in the case that a surplus electrical power is generated, the generated surplus electrical power can be received by the electrical power storage device.

According to the above configuration, even if the fuel that is supplied to the engine is reduced, the engine stall of the engine can be suppressed.

### Supplementary Note 2

In the control device according to Supplementary Note 1, in response to the determination unit determining that the residual capacity of the electrical power storage device becomes equal to or less than the second threshold value (SOC_tar) that is smaller than the first threshold value after the residual capacity reduction control is started, the first control unit may terminate the residual capacity reduction control.

### Supplementary Note 3

The control device according to Supplementary Note 1 may further include the second control unit (92) configured to control the fuel supply device (38a) configured to supply the fuel to the engine, wherein, when the first control unit is executing the residual capacity reduction control, the second control unit may limit the amount of the fuel supplied to the engine.

### Supplementary Note 4

In the control device according to Supplementary Note 3, in response to the determination unit determining that the residual capacity of the electrical power storage device becomes equal to or less than the second threshold value that is smaller than the first threshold value after the residual capacity reduction control is started, the first control unit may terminate the residual capacity reduction control, and together with the first control unit terminating the residual capacity reduction control, the second control unit may cancel limiting of the amount of the fuel supplied to the engine.

### Supplementary Note 5

In the control device according to Supplementary Note 1, the first control unit may control ON and OFF of the plurality of switching elements (54) connected in series to each other in each of three phase arms provided in the electrical power conversion unit, thereby converting the DC electrical power that is output from the electrical power storage device into the three-phase AC electrical power, adjusting the three-phase AC electrical power, and supplying the three-phase AC electrical power after adjustment to the generator.

### Supplementary Note 6

The electrical power supply system (30) of the present disclosure is an electrical power supply system including the control device according to Supplementary Note 1, the electrical power supply system including: the first electrical power supply circuit (32a) configured to supply, to the first load device, an electrical power that is output from the first electrical power generating device; the second electrical power supply circuit (32b) configured to supply, to the second load device (36b), an electrical power that is output from the second electrical power generating device (34b); and the connection circuit (58a) including the connection device (60a) configured to connect the first electrical power supply circuit and the second electrical power supply circuit, wherein the electrical power storage device is connected to the first electrical power supply circuit in parallel with the first electrical power generating device, and the first control unit can execute the residual capacity reduction control and execute the control for supplying the electrical power from the electrical power storage device to the second electrical power generating device via the connection circuit.

According to the above configuration, the residual capacity of the electrical power storage device can be quickly reduced.

### Supplementary Note 7

The aircraft (10) of the present disclosure is an aircraft including the control device according to any one of Supplementary Notes 1 to 5, wherein the first control unit can execute the residual capacity reduction control before the aircraft transitions from cruise to descent.

### Supplementary Note 8

The control method of the present disclosure is a control method for controlling the first electrical power generating device including the engine, the generator, and the electrical power conversion unit, the control method including: the control step of controlling the electrical power conversion unit in a manner so that an electrical power is supplied from the generator to at least one of the electrical power storage device or the first load device; and the determination step of determining the residual capacity of the electrical power storage device, wherein, in the control step, in response to determining that the residual capacity of the electrical power storage device becomes greater than or equal to the first threshold value in the determination step, the residual capacity reduction control for reducing the residual capacity of the electrical power storage device can be executed by controlling the electrical power conversion unit in a manner so that an electrical power is supplied from the electrical power storage device to the generator.

### Supplementary Note 9

The non-transitory storage medium of the present disclosure stores the program for causing the computer to execute the control method according to Supplementary Note 8.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of the operations and the order of the processes are illustrated as examples, and the present disclosure is not necessarily limited to these features. The same also applies to cases in which numerical values or mathematical expressions are used in the description of the above-described embodiments.

1. A control device that controls a first electrical power generating device including an engine, a generator, and an electrical power conversion unit, the control device comprising one or more processors that execute computer-executable instructions stored in a memory,
wherein the one or more processors execute the computer-executable instructions to cause the control device to:
control the electrical power conversion unit in a manner so that an electrical power is supplied from the generator to at least one of an electrical power storage device or a first load device;
determine a residual capacity of the electrical power storage device; and
in response to determining that the residual capacity of the electrical power storage device becomes greater than or equal to a first threshold value, execute residual capacity reduction control for reducing the residual capacity of the electrical power storage device by controlling the electrical power conversion unit in a manner so that an electrical power is supplied from the electrical power storage device to the generator.

2. The control device according to claim 1, wherein
in response to determining that the residual capacity of the electrical power storage device becomes equal to or less than a second threshold value that is smaller than the first threshold value after the residual capacity reduction control is started, the one or more processors cause the control device to terminate the residual capacity reduction control.

3. The control device according to claim 1, wherein
the one or more processors cause the control device to:
control a fuel supply device configured to supply a fuel to the engine; and
when the residual capacity reduction control is being executed, limit an amount of the fuel supplied to the engine.

4. The control device according to claim 3, wherein
in response to determining that the residual capacity of the electrical power storage device becomes equal to or less than a second threshold value that is smaller than the first threshold value after the residual capacity reduction control is started, the one or more processors cause the control device to:
terminate the residual capacity reduction control; and
together with terminating the residual capacity reduction control, cancel limiting of the amount of the fuel supplied to the engine.

5. The control device according to claim 1, wherein
the one or more processors cause the control device to control ON and OFF of a plurality of switching elements connected in series to each other in each of three phase arms provided in the electrical power conversion unit, thereby converting a direct current electrical power that is output from the electrical power storage device into a three-phase alternating current electrical power, adjusting the three-phase alternating current electrical power, and supplying the three-phase alternating current electrical power after adjustment to the generator.

6. An electrical power supply system comprising:
the control device according to claim 1;
a first electrical power supply circuit configured to supply, to the first load device, an electrical power that is output from the first electrical power generating device;
a second electrical power supply circuit configured to supply, to a second load device, an electrical power that is output from a second electrical power generating device; and
a connection circuit including a connection device configured to connect the first electrical power supply circuit and the second electrical power supply circuit,
wherein the electrical power storage device is connected to the first electrical power supply circuit in parallel with the first electrical power generating device, and
the one or more processors execute the computer-executable instructions to cause the control device to execute the residual capacity reduction control and execute control for supplying the electrical power from the electrical power storage device to the second electrical power generating device via the connection circuit.

7. An aircraft comprising the control device according to claim 1,
wherein the one or more processors execute the computer-executable instructions to cause the control device to execute the residual capacity reduction control before the aircraft transitions from cruise to descent.

8. A control method for controlling, by one or more processors, a first electrical power generating device including an engine, a generator, and an electrical power conversion unit, the control method comprising:
controlling the electrical power conversion unit in a manner so that an electrical power is supplied from the generator to at least one of an electrical power storage device or a first load device; and
determining a residual capacity of the electrical power storage device,
wherein the controlling of the electrical power conversion unit includes, in response to determining, in the determining of the residual capacity, that the residual capacity of the electrical power storage device becomes greater than or equal to a first threshold value, executing residual capacity reduction control for reducing the residual capacity of the electrical power storage device by controlling the electrical power conversion unit in a manner so that an electrical power is supplied from the electrical power storage device to the generator.

9. A non-transitory storage medium storing a program for causing a computer to execute the control method according to claim 8.
